(19) United States
(12) Patent Application Publication
(10) Pub. No.: US 2022/0393409 A1
(43) Pub. Date: Dec. 8, 2022

(54) CONNECTOR AND METHOD FOR CONNECTING A COAXIAL CABLE TO A PRINTED CIRCUIT BOARD

(71) Applicant: CommScope Technologies LLC, Hickory, NC (US)

(72) Inventors: Hongjuan An, Suzhou (CN); Jin Liu, Suzhou (CN); Yuanyao Zhou, Suzhou (CN); Yujun Zhang, Suzhou (CN)

(21) Appl. No.: 17/732,928

(22) Filed: Apr. 29, 2022

(30) Foreign Application Priority Data
Jun. 3, 2021 (CN) 202110616556.3

(51) Int. Cl. H01R 24/50; H01R 43/02; H01R 43/20

(52) U.S. Cl. CPC H01R 24/50; H01R 43/0256; H01R 43/205; H01R 2201/02; H01R 2201/24

(57) ABSTRACT

The present disclosure relates to a connector and method for connecting a coaxial cable to a printed circuit board. The connector comprises: a connector, which comprises a cavity penetrating the connector, such that the connector body comprises a first opening and a second opening; an inner contact arranged in the cavity of the connector body, wherein the first end of the inner contact extends from the first opening and the second end of the internal contact is located in the cavity; a plurality of outer contacts arranged on the end face of the connector body, which extend in a direction perpendicular to the end face; a dielectric spacer provided in the cavity of the connector body for separating the inner contact from the plurality of outer contacts; and a bushing element being attachable to the outer conductor of the coaxial cable to form an electrical connection between the plurality of outer contacts of the connector and the outer conductor of the coaxial cable. The connector further comprises a recess formed by a third opening provided on its side, wherein the recess includes an inner peripheral surface and a bottom surface with a hole, and the bushing element can be placed in the recess.

### RELATED APPLICATION

The present application claims priority from and the benefit of Chinese Patent Application No. 202110616556.3, filed Jun. 3, 2021, the disclosure of which is hereby incorporated herein by reference in full.

### FIELD OF THE INVENTION

The present disclosure generally relates to electrical connectors. More particularly, the present disclosure relates to a connector for connecting a coaxial cable to a printed circuit board, a coaxial cable-connector assembly including the connector, and a method for connecting a coaxial cable to a printed circuit board.

### BACKGROUND OF THE INVENTION

Coaxial cables are widely used in base station antenna systems as radio frequency (RF) transmission lines. FIG. 1 schematically shows a conventional method of connection between a coaxial cable 1 and a printed circuit board 2 in a base station antenna system. As shown in FIG. 1, when connected with the printed circuit board 2, the coaxial cable 1 usually extends parallel to the printed circuit board 2. In order to connect the coaxial cable 1 and the printed circuit board 2, the insulating sheath 3 at one end of the coaxial cable 1 can be stripped off to expose the outer conductor 4. The exposed outer conductor 4 is soldered to the outer conductor pad 5 provided on the side of the printed circuit board 2. The outer conductor pad 5 is electrically connected with the ground plane of the printed circuit board 2, thereby grounding the outer conductor 4 of the coaxial cable 1.

The exposed outer section of the outer conductor 4 and the insulating dielectric layer between the outer conductor 4 and the inner conductor 6 are stripped off, thereby exposing the inner conductor 6. A via 7 is provided next to the outer conductor pad 5, and the inner conductor 6 of the coaxial cable 1 is bent and passed through the via 7 in a direction perpendicular to the printed circuit board 2. The inner conductor 6 is soldered to a metal pattern on the other side of the printed circuit board 2, thereby realizing the connection between the coaxial cable 1 and the printed circuit board 2.

The above-mentioned connection method of the coaxial cable 1 and the printed circuit board 2 has many disadvantages, such as the following:

Firstly, the coaxial cable is used to transmit RF signals that easily radiate energy. Since the inner conductor 6 of the coaxial cable 1 is exposed to the environment, the energy loss associated with the exposed inner conductor 6 will be large. Secondly, the bending of the inner conductor 6 generates parasitic inductance, which may make it more difficult to achieve good impedance matching between the coaxial cable 1 and the printed circuit board 2, and therefore may increase the return loss. When the operating frequency of the system is high, the effect of the parasitic inductance becomes more significant. Thirdly, it is difficult to link the coaxial cable 1 with the printed circuit board 2 accurately, especially because the outer conductor 4 extends parallel to the printed circuit board 2 such that the outer conductor 4 and the outer conductor pad 5 are joined by only one intersection line, which further increases the uncertainty of the connection position. In particular, in beamforming antennas, there are multiple coaxial cables transmitting in parallel, and the error caused by the uncertainty of the connection position may make the phase synchronization between the coaxial cables worse. This will adversely affect the beamforming characteristics of the antenna.

With the development of technology, some base station antenna systems require further reduction of energy loss of RF signals transmitted by coaxial cables in order to obtain higher gain. Therefore, there is a need to improve the existing connection method and device.

### SUMMARY OF THE INVENTION

One of the objectives of the present disclosure is to overcome at least one shortcoming in the prior art.

In a first aspect of the present disclosure, a connector for connecting a coaxial cable to a printed circuit board is provided. The connector may comprise: a connector body, which comprises a cavity throughout the connector body along a longitudinal direction of the connector body, such that the connector body comprises a first opening and a second opening opposite to the first opening; an inner contact provided in the cavity of the connector body, wherein the first end of the inner contact extends from the first opening such that it is able to form an electrical connection with the traces of the printed circuit board, and the second end of the internal contact is located in the cavity, such that it is able to form an electrical connection with the inner conductor of the coaxial cable; a plurality of outer contacts arranged on an end face of the connector body, wherein the plurality of outer contacts extend in a direction perpendicular to the end face, such that they are able to form an electrical connection with the ground plane of the printed circuit board; a dielectric spacer provided in the cavity of the connector body for separating the inner contact from the plurality of outer contacts; and a bushing element being attachable an outer conductor of the coaxial cable, wherein an electrical connection is formed between the plurality of outer contacts of the connector and the outer conductor of the coaxial cable via the bushing element and the connector body, of which, the connector body further includes a recess formed by a third opening provided on its side that extends along a direction perpendicular to the longitudinal direction of the connector body, wherein the recess includes an inner peripheral surface and a bottom surface with a hole, and the bushing element is disposable in the recess.

According to an embodiment of the present disclosure, the connector further comprises a fastening element for fastening the bushing element and the coaxial cable in the recess of the connector body.

According to an embodiment of the present disclosure, the second end of the internal contact of the connector has a hole extending in a direction perpendicular to a longitudinal direction of the inner contact, and the inner conductor of the coaxial cable is receivable in the hole of the internal contact to realize the electrical connection between the inner conductor and the inner contact.

According to an embodiment of the present disclosure, the inner conductor of the coaxial cable is soldered into the hole of the inner contact.

According to an embodiment of the present disclosure, the inner conductor of the coaxial cable is soldered into the hole of the inner contact through the second opening.

According to an embodiment of the present disclosure, one end of the bushing element is provided with a flange, which comprises a first flange face and a second flange face opposite to the first flange face, and the fastening element abuts the second flange face against the bottom surface of the recess by pushing against the first flange face.

According to an embodiment of the present disclosure, the fastening element comprises an external thread, and the inner peripheral surface of the recess comprises an internal thread that matches the external thread, such that the fastening element can be screwed into the recess.

According to an embodiment of the present disclosure, the fastening element comprises a first section with a first cavity and a second section with a second cavity, and wherein the first cavity is able to accommodate at least a part of the bushing element, and the second cavity is able to accommodate at least a part of the coaxial cable.

According to an embodiment of the present disclosure, a boss is provided between a root of each outer contact and the end face of the connector body.

According to an embodiment of the present disclosure, the outer contact, the boss and the connector body are integrally formed.

According to an embodiment of the present disclosure, the outer contact is configured as a column with a quadrilateral cross-section.

According to an embodiment of the present disclosure, the connector further comprises an end cap element that can seal the second opening.

In a second aspect of the present disclosure, a coaxial cable-connector assembly is provided. The coaxial cable-connector assembly may comprise: a coaxial cable, which comprises an inner conductor, an outer conductor, and a dielectric layer provided between the inner conductor and the outer conductor; and a connector according to the present disclosure.

According to an embodiment of the present disclosure, the bushing element is pre-connected to the outer conductor of the coaxial cable.

According to an embodiment of the present disclosure, the bushing element is positioned in the recess of the connector and abuts against the bottom surface of the recess, and the inner conductor of the coaxial cable passes through the hole on the bottom surface of the recess to form an electrical connection with the inner contact of the connector.

According to an embodiment of the present disclosure, the dielectric layer of the coaxial cable can extend through the hole on the bottom surface of the recess to enter the cavity of the connector body.

In a third aspect of the present disclosure, a method for connecting a coaxial cable to a printed circuit board is provided. The method may comprise: providing a connector according to the present disclosure; soldering the connector body of the connector to the printed circuit board; soldering the bushing element of the connector around the outer conductor of the coaxial cable; and positioning the bushing element in the recess of the connector body, such that the bushing element abuts against the bottom surface of the recess, and the inner conductor of the coaxial cable forms an electrical connection with the inner contact of the connector.

According to an embodiment of the present disclosure, the method comprises: inserting the inner contact and the outer contact of the connector respectively into the first via and the second via of the printed circuit board from the first side of the printed circuit board; and soldering the inner contact and the outer contact of the connector on the printed circuit board from the second side of it.

According to an embodiment of the present disclosure, the method comprises: soldering the inner conductor of the coaxial cable to the second end of the inner contact of the connector through the second opening of the connector body.

According to an embodiment of the present disclosure, the method comprises: sealing the second opening of the connector body after soldering the inner conductor of the coaxial cable to the second end of the inner contact of the connector.

It should be noted that various aspects of the present disclosure described for one embodiment may be included in other different embodiments, even though specific description is not made for the other different embodiments. In other words, all the embodiments and/or features of any embodiment may be combined in any manner and/or combination, as long as they are not contradictory to each other.

### DESCRIPTION OF THE DRAWINGS

A plurality of aspects of the present disclosure will be better understood after reading the following specific embodiments with reference to the attached drawings. Among the attached drawings:

FIG. 1 is a schematic perspective view of a conventional connection method of a coaxial cable and a printed circuit board;

FIG. 2 is a schematic perspective view of a coaxial cable-connector assembly according to an embodiment of the present disclosure;

FIG. 3 is a cross-sectional view of the coaxial cable-connector assembly shown in FIG. 2;

FIG. 4 is a schematic perspective view of a connector body according to an embodiment of the present disclosure;

FIG. 5 is a schematic perspective view of a bushing element according to an embodiment of the present disclosure;

FIG. 6 is a schematic perspective view of a fastening element according to an embodiment of the present disclosure;

FIG. 7 and FIG. 8 respectively show the connection between the printed circuit board and the coaxial cable-connector assembly according to the present disclosure from both sides of the printed circuit board.

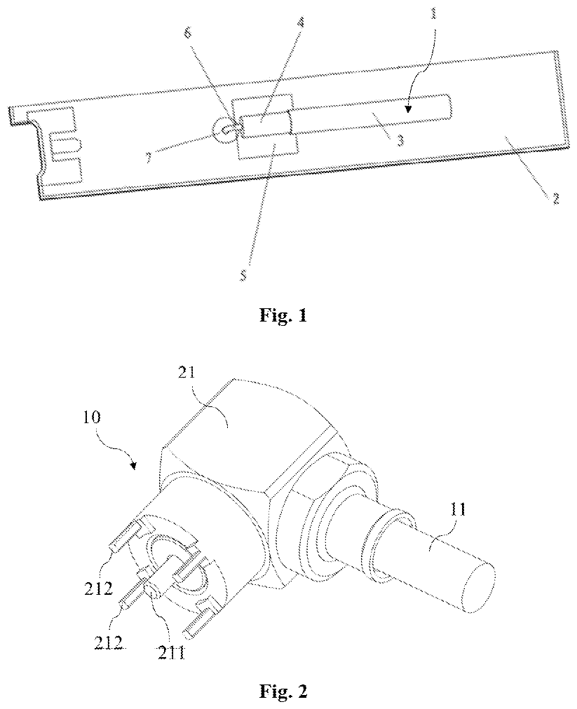

It should be understood that in all the attached drawings, the same reference numerals denote the same elements. In the attached drawings, for clarity, the size of certain features is not drawn to scale as it may change.

### DETAILED DESCRIPTION OF SPECIFIC EMBODIMENTS

The present disclosure will be described below with reference to the attached drawings, and the attached drawings illustrate certain embodiments of the present disclosure. However, it should be understood that the present disclosure may be presented in many different ways and is not limited to the embodiments described below; in fact, the embodiments described below are intended to make the content of the present disclosure more complete and to fully explain the protection scope of the present disclosure to those of ordinary skill in the art. It should also be understood that the embodiments disclosed in the present disclosure may be combined in various ways so as to provide more additional embodiments.

It should be understood that the words in the Specification are only used to describe specific embodiments and are not intended to limit the present disclosure. Unless otherwise defined, all terms (including technical terms and scientific terms) used in the Specification have the meanings commonly understood by those of ordinary skill in the art. For brevity and/or clarity, well-known functions or structures may not be further described in detail.

The singular forms “a”, “an”, “the” and “this” used in the Specification all include plural forms unless clearly indicated. The words “include”, “contain” and “have” used in the Specification indicate the presence of the claimed features, but do not exclude the presence of one or a plurality of other features. The word “and/or” used in the Specification includes any or all combinations of one or a plurality of the related listed items.

In the Specification, when it is described that an element is “on” another element, “attached” to another element, “connected” to another element, “coupled” with another element, or “in contact with” another element, etc., the element may be directly on another element, attached to another element, connected to another element, coupled with another element, or in contact with another element, or an intermediate element may be present.

In the Specification, the terms “first”, “second”, “third”, etc. are only used for convenience of description and are not intended for limitation. Any technical features represented by “first”, “second”, “third”, etc. are interchangeable.

In the Specification, terms expressing spatial relations such as “upper”, “lower”, “front”, “rear”, “top”, and “bottom” may describe the relation between one feature and another feature in the attached drawings. It should be understood that, in addition to the locations shown in the attached drawings, the words expressing spatial relations further include different locations of a device in use or operation. For example, when a device in the attached drawings is turned upside down, the features originally described as being “below” other features now can be described as being “above” the other features”. The device may also be oriented by other means (rotated by 90 degrees or at other locations), and at this time, a relative spatial relation will be explained accordingly.

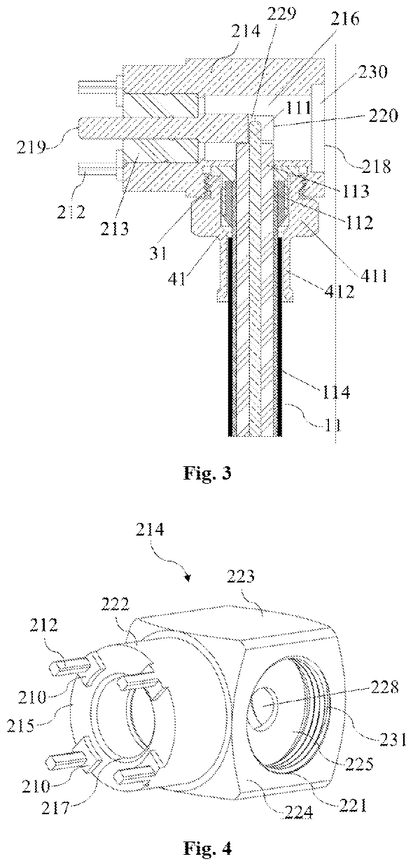

Referring to FIG. 2 and FIG. 3, a coaxial cable-connector assembly 10 according to an embodiment of the present disclosure is shown. The coaxial cable-connector assembly 10 may include a coaxial cable 11 and a connector 21 which may be mechanically and electrically connected with the coaxial cable 11. In the embodiment according to the present disclosure, the connector 21 is configured to connect the coaxial cable 11 to the printed circuit board. For this purpose, the connector 21 may be configured as a right-angle connector to facilitate the connection between the coaxial cable 11 and the printed circuit board.

The coaxial cable 11 may include an inner conductor 111, an outer conductor 112, a dielectric layer 113 provided between the inner conductor 111 and the outer conductor 112, and an outer conductor sheath 114 provided outside the outer conductor 112. The connector 21 may include an inner contact 211, a plurality of outer contacts 212 arranged around the inner contact 211, and a dielectric spacer 213 arranged between the inner contact 211 and the outer contacts 212 for separating them. The plurality of outer contacts 212 may be spaced apart from each other by a predetermined distance or angle as required.

The connector 21 may have a connector body 214. The outer contact 212 may be arranged on the end face 215 of the connector body 214 and extend perpendicular to the end face 215. The connector body 214 may include a cavity 216 throughout the entire connector body 214 along the longitudinal direction of the connector body 214, such that the connector body 214 comprises a first opening 217 and a second opening 218 opposite to the first opening 217. The inner contact 211 and the dielectric spacer 213 may be positioned in the cavity 216 via the first opening 217. The first end 219 of the inner contact 211 extends from the first opening 217 and the second end 220 is located in the cavity 216.

As shown more clearly in FIG. 4, in an embodiment according to the present disclosure, the outer contact 212 may be configured in the form of a column or cylinder. A boss or step 210 may be provided between the root of the outer contact 212 and the end face 215 of the connector body 214. The surface area of the boss 210 is larger than the cross-sectional area of the root of the outer contact 212, such that when the connector 21 is connected to the printed circuit board, the boss 210 is clamped between the surface of the printed circuit board and the end face 215 of the connector body 214. The boss 210 can effectively prevent solder from flowing to the surface of the printed circuit board and affecting the electrical connection performance of the printed circuit board during the process of soldering the connector 21 to the printed circuit board. In an embodiment according to the present disclosure, the outer contacts 212, the boss 210, and the connector body 214 may be integrally formed. In this embodiment, in order to facilitate processing, the outer contacts 212 may have a substantially quadrilateral cross-section. In other embodiments according to the present disclosure, the outer contacts 212, the boss 210, and the connector body 214 may be separate components. In this embodiment, the outer contacts 212 and the boss 210 may be positioned on the end face 215 of the connector body 214 in any suitable manner.

As shown more clearly in FIG. 4, the connector body 214 may also include a third opening 221 for receiving one end of the coaxial cable. The third opening 221 may be provided on the side of the connector body 214 and extend along a direction perpendicular to the longitudinal direction of the connector body 214, such that the extension direction of the coaxial cable 11 extended through the third opening 221 is perpendicular to the longitudinal direction of the connector body 214 to form a right-angle connector. In an embodiment according to the present disclosure, the connector body 214 may include a first part 222 and a second part 223. The cross-section of the first part 222 may be cylindrical. The cross section of the second part 223 may be quadrilateral, such that the second part 223 includes four sides 224. The outer contact 212 may be arranged on the end face 215 of the first part 222, and the third opening 221 may be arranged on one of the sides 224 of the second part 223. The third opening 221 may extend to a certain depth along a direction perpendicular to the side 224, but not to the cavity 216, thereby forming a recess 225. The recess 225 has a bottom surface and an inner peripheral surface, and the bottom surface of the recess 225 may be provided with a hole 228. The dielectric layer 113 and the inner conductor 111 of the coaxial cable 11 may extend through the hole 228 to enter the cavity 216.

In order to ensure a good electrical connection between the coaxial cable 11 and the connector 21, the connector 21 may include a separate bushing element 31. The bushing element 31 may be attached (e.g., via soldering) around the outer conductor 112 of the coaxial cable 11 and may be set in the recess 225 of the connector 21 via the third opening 221 of the connector 21. When the bushing element 31 is set in the recess 225 of the connector 21, the end face of the bushing element 31 can abut the bottom surface of the recess 225, such that the electrical connection between the outer conductor 112 of the coaxial cable 11 and the outer contact 212 of the connector 21 can be realized through the bushing element 31 and the connector body 214. At the same time, the inner conductor 111 of the coaxial cable 11 and the second end 220 of the inner contact 211 of the connector 21 can be connected to each other to realize an electrical connection between the two. Specifically, the second end 220 of the inner contact 211 of the connector 21 may have a hole 229 extending in a direction perpendicular to the longitudinal direction of the inner contact 211. The inner conductor 111 of the coaxial cable 11 may extend into the hole 229 of the inner contact 211 of the connector 21 to realize an electrical connection between the inner conductor 111 and the inner contact 211. The inner conductor 111 of the coaxial cable 11 can be soldered or otherwise attached to the hole 229 of the inner contact 211 of the connector 21 in an appropriate manner to ensure reliable mechanical connection and good electrical connection performance between the inner conductor 111 and the inner contact 211. The soldering tool can enter the cavity 216 through the second opening 218 of the connector 21 for soldering. After soldering, the second opening 218 can also be sealed with an end cover element, so as to avoid the energy loss of RF signals caused by the direct exposure of the connection part between the inner conductor 111 of the coaxial cable 11 and the inner contact 211 of the connector 21 to the environment. To this end, a recess 230 suitable for accommodating and positioning the end cover element can also be provided at the second opening 218.

The connector 21 may also comprise a separate fastening element 41. The fastening element 41 is used to fasten the bushing element 31 and therefore one end of the coaxial cable 11 in the recess 225 of the connector 21 to form a firm mechanical connection between the coaxial cable 11 and the connector 21.

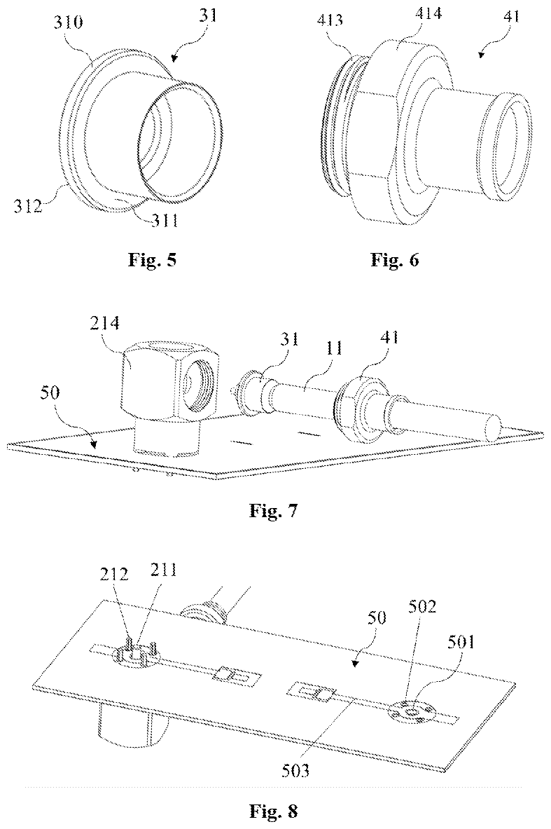

Referring to FIG. 5, in an embodiment according to the present disclosure, the bushing element 31 may be configured in a cylindrical shape. The bushing element 31 has a flange 310 at one end. The flange 310 comprises a first flange face 311 and a second flange face 312 opposite to the first flange face 311. When placed in the recess 225 of the connector 21, the fastening element 41 can abut the second flange face 312 against the bottom surface of the recess 225 by pressing on the first flange face 311. The end of the bushing element 31 where the flange 310 is provided has a hole through which only the dielectric layer 113 and the inner conductor 111 of the coaxial cable 11 extend.

Referring to FIG. 3 and FIG. 6, in an embodiment according to the present disclosure, the fastening element 41 may be configured as a fastening sleeve. The fastening element 41 may comprise a first section 411 having a first cavity and a second section 412 having a second cavity. The first cavity can accommodate the part of the bushing element 31 except for the flange 310, and the second cavity can accommodate a part of the coaxial cable 11 to protect the coaxial cable 11. At least a part of the first section 411 of the fastening element 41 is provided with an external thread 413. Accordingly, the inner peripheral surface of the recess 225 of the connector 21 is provided with an internal thread 231 that matches the external thread 413. Therefore, the fastening element 41 may be screwed into the recess 225 to fasten the bushing element 31. In an embodiment according to the present disclosure, the outer circumference of the fastening element 41 may also be provided with a flange 414. The flange 414 can abut against the side of the connector body 214 with the third opening 221 to prevent the fastening element 41 from being screwed into the recess 225 to a depth exceeding the expected depth and causing damage to the connector body 214.

In other embodiments according to the present disclosure, other fastening methods may be used to fasten the bushing element 31 without using the fastening element 41. For example, an interference fit between the bushing element 31 and the inner peripheral surface of the recess 225 can be used to directly fasten the bushing element 31 and therefore one end of the coaxial cable 11 in the recess 225 of the connector 21.

FIG. 7 and FIG. 8 show the connection between the coaxial cable-connector assembly 10 and the printed circuit board 50. The printed circuit board 50 may be provided with a first via 501 for connecting with the inner contact 211 of the connector 21 and a plurality of second vias 502 for connecting with the plurality of outer contacts 212 of the connector 21. The first via 501 is connected to the trace 503 on the printed circuit board, and the second via 502 is connected to the ground plane of the printed circuit board. In order to connect the coaxial cable-connector assembly 10 to the printed circuit board 50, one or more of the following steps may be implemented:

1) Solder the connector body 214 of the connector 21 to the printed circuit board 50. Specifically, the inner contact 211 and the outer contact 212 of the connector 21 can be respectively inserted into the first via 501 and the second via 502 of the printed circuit board 50 from the first side of the printed circuit board 50, and the inner contact 211 and the outer contact 212 of the connector 21 can then be soldered on the printed circuit board from the second side of the printed circuit board 50. In this way, the inner contact 211 of the connector 21 will form an electrical connection with the trace of the printed circuit board 50, and the outer contact 212 will form a ground connection with the ground plane of the printed circuit board 50. During the soldering process, the boss 220 can effectively prevent the solder from flowing onto the surface of the first side of the printed circuit board 50;
2) Pre-solder the bushing element 31 of the connector 21 around the outer conductor 112 of the coaxial cable 11, and extend the inner conductor 111 and the dielectric layer 113 of the coaxial cable 11 by a certain length from the bushing element 31;
3) Insert the end of the coaxial cable 11 with the pre-soldered bushing element 31 into the recess 225 of the connector body 214 through the third opening 221 of the connector body 214, such that the bushing element 31 abuts against the bottom surface of the recess 225 and the inner conductor 111 extending from the bushing element 31 is inserted into the hole 229 provided at the second end 220 of the inner contact 211 of the connector 21:
4) Solder the part of the inner conductor 111 of the coaxial cable 11 inserted into the hole 229 of the inner contact 211 of the connector 21 together with the inner contact 211 of the connector 21 through the second opening 218 of the connector body 214, so as to realize the mechanical connection and electrical connection between the inner conductor 111 of the coaxial cable 11 and the inner contact 211 of the connector 21;
5) Screw the fastening element 41 sheathed around the coaxial cable 11 into the recess 225 of the connector body 214 to achieve a reliable connection between the coaxial cable 11 and the connector 21;
6) Seal the second opening 218 of the connector body 214 with an end cover element.

It should be noted that Steps 1 to 6 do not need to be implemented in the above order, but can be adjusted arbitrarily according to the actual situation. For example, Step 2 can be implemented before Step 1, Step 5 can be implemented before Step 4, and so on. In addition, one or more of Steps 1 to 6 may be omitted as necessary. For example, the second opening 218 of the connector body 214 may not be sealed with an end cap element, and Step 6 may thereby be omitted; the bushing element may be fastened by other means (for example, the bushing element 31 may be directly fastened via the interference fit between it and the inner peripheral surface of the recess 225), and Step 5 may thereby be omitted.

The connector 21 according to the present disclosure can effectively reduce the energy loss of radio frequency signals transmitted by the coaxial cable 11, thereby obtaining a higher gain. The coaxial cable-connector assembly 10 according to the present disclosure can realize the connection between the coaxial cable 11 and the connector 21 as well as between the coaxial cable-connector assembly 10 and the printed circuit board 50 in a flexible manner.

In addition, since the bushing element 31 can be pre-soldered around the outer conductor 112 of the coaxial cable 11, the electrical connection performance of the coaxial cable 11 to which the bushing element 31 is soldered can be measured in advance before installing the coaxial cable 11 to the connector 21 (the electrical connection performance is mainly affected by the soldering quality between the bushing element 31 and the outer conductor 112 of the coaxial cable 11). If the electrical connection performance is not good, the bushing element 31 can be re-soldered or replaced with a new bushing element 31 without replacing or discarding the entire coaxial cable-connector assembly 10. In this way, not only is the waste of materials avoided, but the coaxial cable-connector assembly 10 eventually formed is also ensured to have a significantly improved qualification rate.

The coaxial cable-connector assembly 10 according to the present disclosure can be used in various devices, such as in existing base station antenna layouts or other filter units.

Exemplary embodiments according to the present disclosure have been described above with reference to the attached drawings. However, those of ordinary skill in the art should understand that various changes and modifications can be made to the exemplary embodiments of the present disclosure without departing from the gist and scope of the present disclosure. All changes and modifications are included in the protection scope of the present disclosure defined by the claims. The present disclosure is defined by the attached claims, and equivalents of these claims are also included.

1. A connector for connecting a coaxial cable to a printed circuit board, comprising:
a connector body, which comprises a cavity throughout the connector body along a longitudinal direction of the connector body, such that the connector body includes a first opening and a second opening opposite to the first opening;
an inner contact arranged in the cavity of the connector body, wherein the first end of the inner contact extends from the first opening such that it is able to form an electrical connection with the traces of the printed circuit board, and the second end of the internal contact is located in the cavity, such that it is able to form an electrical connection with the inner conductor of the coaxial cable;
a plurality of outer contacts arranged on an end face of the connector body, wherein the plurality of outer contacts extend in a direction perpendicular to the end face, such that they are able to form an electrical connection with the ground plane of the printed circuit board;
a dielectric spacer provided in the cavity of the connector body for separating the inner contact from the plurality of outer contacts; and
a bushing element being attachable to an outer conductor of the coaxial cable, wherein an electrical connection is formed between the plurality of outer contacts of the connector and the outer conductor of the coaxial cable via the bushing element and the connector body;
wherein the connector body further includes a recess formed by a third opening provided on its side that extends along a direction perpendicular to the longitudinal direction of the connector body, wherein the recess includes an inner peripheral surface and a bottom surface with a hole, and the bushing element is disposable in the recess.

2. The connector according to claim 1, wherein the connector further comprises a fastening element for fastening the bushing element and the coaxial cable in the recess of the connector body.

3. The connector according to claim 1, wherein the second end of the internal contact of the connector has a hole extending in a direction perpendicular to a longitudinal direction of the inner contact, and the inner conductor of the coaxial cable is receivable in the hole of the internal contact to realize the electrical connection between the inner conductor and the inner contact.

4. The connector according to claim 3, wherein the inner conductor of the coaxial cable is soldered into the hole of the inner contact.

5. The connector according to claim 4, wherein the inner conductor of the coaxial cable is soldered into the hole of the inner contact through the second opening.

6. The connector according to claim 2, wherein one end of the bushing element is provided with a flange, which comprises a first flange face and a second flange face opposite to the first flange face, and the fastening element abuts the second flange face against the bottom surface of the recess by pushing against the first flange face.

7. The connector according to claim 2, wherein the fastening element comprises an external thread, and the inner peripheral surface of the recess comprises an internal thread that matches the external thread, such that the fastening element can be screwed into the recess.

8. The connector according to claim 7, wherein the fastening element comprises a first section with a first cavity and a second section with a second cavity, and wherein the first cavity is able to accommodate at least a part of the bushing element, and the second cavity is able to accommodate at least a part of the coaxial cable.

9. The connector according to claim 1, wherein a boss is provided between a root of each outer contact and the end face of the connector body.

10. The connector according to claim 9, wherein the outer contact, the boss and the connector body are integrally formed.

11. The connector according to claim 10, wherein the outer contact is configured as a column with a quadrilateral cross-section.

12. The connector according to claim 1, wherein the connector further comprises an end cap element that can seal the second opening.

13. A coaxial cable-connector assembly comprising:
a coaxial cable, which comprises an inner conductor, an outer conductor, and a dielectric layer provided between the inner conductor and the outer conductor; and
a connector as defined in claim 1.

14. The coaxial cable-connector assembly according to claim 13, wherein the bushing element is pre-connected to the outer conductor of the coaxial cable.

15. The coaxial cable-connector assembly according to claim 14, wherein the bushing element is positioned in the recess of the connector and abuts against the bottom surface of the recess, and the inner conductor of the coaxial cable passes through the hole on the bottom surface of the recess to form an electrical connection with the inner contact of the connector.

16. The coaxial cable-connector assembly according to claim 13, wherein the dielectric layer of the coaxial cable can extend through the hole on the bottom surface of the recess to enter the cavity of the connector body.

17. A method for connecting a coaxial cable to a printed circuit board, comprising:
providing a connector according to claim 1;
soldering the connector body of the connector to the printed circuit board;
soldering the bushing element of the connector around the outer conductor of the coaxial cable; and
positioning the bushing element in the recess of the connector body, such that the bushing element abuts against the bottom surface of the recess, and the inner conductor of the coaxial cable forms an electrical connection with the inner contact of the connector.

18. The method according to claim 17, comprising:
inserting the inner contact and the outer contact of the connector respectively into the first via and the second via of the printed circuit board from the first side of the printed circuit board; and
soldering the inner contact and the outer contact of the connector on the printed circuit board from the second side of the printed circuit board.

19. The method according to claim 17, comprising:
soldering the inner conductor of the coaxial cable to the second end of the inner contact of the connector through the second opening of the connector body.

20. The method according to claim 19, comprising:
sealing the second opening of the connector body after soldering the inner conductor of the coaxial cable to the second end of the inner contact of the connector.
